(19) United States
(12) Patent Application Publication
(10) Pub. No.: US 2025/0374034 A1
(43) Pub. Date: Dec. 4, 2025

(54) METHODS, DEVICES, AND SYSTEMS FOR CAPABILITY COORDINATION IN DUAL-CONNECTION

(71) Applicant: ZTE Corporation, Shenzhen (CN)

(72) Inventors: Wenting LI, Shenzhen (CN); Jing LIU, Shenzhen (CN); He HUANG, Shenzhen (CN); Li NIU, Shenzhen (CN)

(73) Assignee: ZTE Corporation, Shenzhen (CN)

(21) Appl. No.: 19/299,971

(22) Filed: Aug. 14, 2025

Related U.S. Application Data
(63) Continuation of application No. PCT/CN2023/076558, filed on Feb. 16, 2023.

(51) Int. Cl. H04W 8/22; H04B 7/0456; H04W 76/15

(52) U.S. Cl. CPC H04W 8/22; H04B 7/046; H04W 76/15

(57) ABSTRACT

The present disclosure describes methods, systems, and devices for user equipment (UE) capability coordination in dual-connection (DC). One method includes sending, by a user equipment (UE) to a first network, a UE assistance information comprising UE temporary capability restriction, the UE capability restriction indicating one or more restriction dimensions to the first network. Another method includes receiving, by a first network from a UE, a UE assistance information comprising UE temporary capability restriction, the UE capability restriction indicating one or more restriction dimensions to the first network.

### TECHNICAL FIELD

The present disclosure is directed generally to wireless communications. Particularly, the present disclosure relates to methods, devices, and systems for user equipment (UE) capability coordination in dual-connection (DC).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the 5th Generation (5G) mobile communication technology, a user equipment (UE), for example, a smart phone, may experience a temporary restriction on its communication capability. For example, when the UE works at dual active state with two networks, the UE may have the temporary UE capability restriction for connection to the two networks. There are various problems/issues associated with this situation, for example, how the UE indicates the temporary UE capability restriction to one or all of the two networks.

The present disclosure describes various embodiments for capability coordination in dual-connection, addressing at least one of issues/problems described in the present disclosure, and improving the performance of the wireless communication.

### SUMMARY

This document relates to methods, systems, and devices for wireless communication, and more specifically, for coordinating user equipment (UE) capability in dual-connection (DC).

In one embodiment, the present disclosure describes a method for wireless communication. The method includes sending, by a user equipment (UE) to a first network, a UE assistance information comprising UE temporary capability restriction, the UE capability restriction indicating one or more restriction dimensions to the first network.

In another embodiment, the present disclosure describes a method for wireless communication. The method includes receiving, by a first network from a user equipment (UE), a UE assistance information comprising UE temporary capability restriction, the UE capability restriction indicating one or more restriction dimensions to the first network.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM).

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4 shows an exemplary list of feature set entries of an exemplary embodiment for wireless communication.

FIG. 5 shows an exemplary general procedure of temporary capability reporting of an exemplary embodiment for wireless communication.

FIG. 6A shows a flow diagram of a method for wireless communication.

FIG. 6B shows a flow diagram of another method for wireless communication.

FIG. 7 shows a schematic diagram of an exemplary embodiment for wireless communication.

FIG. 8A shows a schematic diagram of another exemplary embodiment for wireless communication.

FIG. 8B shows a schematic diagram of another exemplary embodiment for wireless communication.

FIG. 9 shows a schematic diagram of another exemplary embodiment for wireless communication.

FIG. 10A shows a schematic diagram of another exemplary embodiment for wireless communication.

FIG. 10B shows a schematic diagram of another exemplary embodiment for wireless communication.

FIG. 11A shows a schematic diagram of another exemplary embodiment for wireless communication.

FIG. 11B shows a schematic diagram of another exemplary embodiment for wireless communication.

FIG. 12A shows a schematic diagram of another exemplary embodiment for wireless communication.

FIG. 12B shows a schematic diagram of another exemplary embodiment for wireless communication.

FIG. 13A shows a schematic diagram of another exemplary embodiment for wireless communication.

FIG. 13B shows a schematic diagram of another exemplary embodiment for wireless communication.

FIG. 14 shows a schematic diagram of another exemplary embodiment for wireless communication.

FIG. 15A shows a schematic diagram of another exemplary embodiment for wireless communication.

FIG. 15B shows a schematic diagram of another exemplary embodiment for wireless communication.

FIG. 16 shows a schematic diagram of another exemplary embodiment for wireless communication.

FIG. 17A shows a schematic diagram of another exemplary embodiment for wireless communication.

FIG. 17B shows a schematic diagram of another exemplary embodiment for wireless communication.

FIG. 17C shows a schematic diagram of another exemplary embodiment for wireless communication.

FIG. 17D shows a schematic diagram of another exemplary embodiment for wireless communication.

FIG. 17E shows a schematic diagram of another exemplary embodiment for wireless communication.

FIG. 17F shows a schematic diagram of another exemplary embodiment for wireless communication.

FIG. 17G shows a schematic diagram of another exemplary embodiment for wireless communication.

FIG. 17H shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for user equipment (UE) capability coordination in dual-connection (DC).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

The present disclosure describes various embodiments for user equipment (UE) capability coordination in dual-connection (DC). Under one or more scenarios, a user equipment (UE) may connect to more than one network nodes at the same time. The network nodes, for example, may include one or more radio access network (RAN) node and/or one or more core network (CN) node. In one implementation, the UE may connect with two network nodes at the same time, which may be referred as “dual-active state”, which need the UE and/or one or more network nodes to coordinate the multiple connections, so as to provide an efficient system for the one or more scenarios.

One scenario may include that, for a UE having multiple subscriber identity modules (Multi-SIMs) (or multiple universal subscriber identity modules (Multi-USIMs), the UE may connect with the multiple networks at the same time. In another scenario, a UE with a single SIM may connect with the multiple networks at the same time. Another scenario may include, a roaming UE may connect multiple networks for different slices. In another scenario, as an enhancement on the slice, a wireless communication system may need to be enable a roaming UE to access network slices from more than one visited public land mobile networks (VPLMNs) simultaneously, which means the UE may connect to the 2 network simultaneously, which is similar to the Multi-SIM. In another scenario, the video, imaging and audio for professional applications (VIAPA) may require a method of enabling a UE to receive data services from one network (e.g. non-public network (NPN)) and to receive paging as well as data services from another network (e.g. public land mobile network (PLMN)) simultaneously, which is similar to the Multi-SIM.

When the UE configures to connect multiple network at the same time, the UE capability may need to be coordinated. In some implementations with radio access capability signalling (RACS), the UE radio access capability may be packaged as a predefined or network defined UE capability ID.

In various embodiments, for the Multi-SIM (or Multi-USIM), the UE may connect to multiple networks simultaneously for different cases.

In some implementations with paging receiving on a second subscriber identity module (SIM2) when a first subscriber identity module (SIM1) is at connected state, it may be solved by time division multiplexing (TDM), e.g. reserving the scheduling gap for the SIM2. There may be no cooperation for that there was not simultaneously connection with 2 networks. However, for the dual receiving/transmitting (RX) UE, this scheme may affect the performance of SIM1 by reserving scheduling gap with paging period. Another solution for the dual RX UE is to reserve part of radio frequency or physical (RF/PHY) resources for the paging receiving. In some implementations with short dual connected state, the SIM1 may be at connected state, and the SIM2 has to do some mobility update, e.g. periodic registration, moving into a new registration area, or response the paging. The UE may need capability cooperation during the short dual connected state. In some implementations with long dual connected state, the UE may have a voice call on the SIM1, meanwhile have some other data service on the SIM2. The UE may need capability cooperation.

There may be some issues/problems that need to be resolved. For example, Multi-SIM (or Multi-USIM) UE's hardware capabilities may be shared by more than one SIMs. To use the hardware efficiently and economically, the related capabilities need to be dynamically split between the more than one SIMs. This may lead to a temporary hardware conflict. For example, the UE is connected to one network (network A), it would have some capability restriction to another network (network B). Thus, the UE need to indicate the capability restriction to the network B when the UE enters into the connected state with network B.

The present disclosure describes various embodiments for UE capability coordination in dual-active state, addressing at least one of issues/problems described above, providing solutions, and improving the performance of the wireless communication.

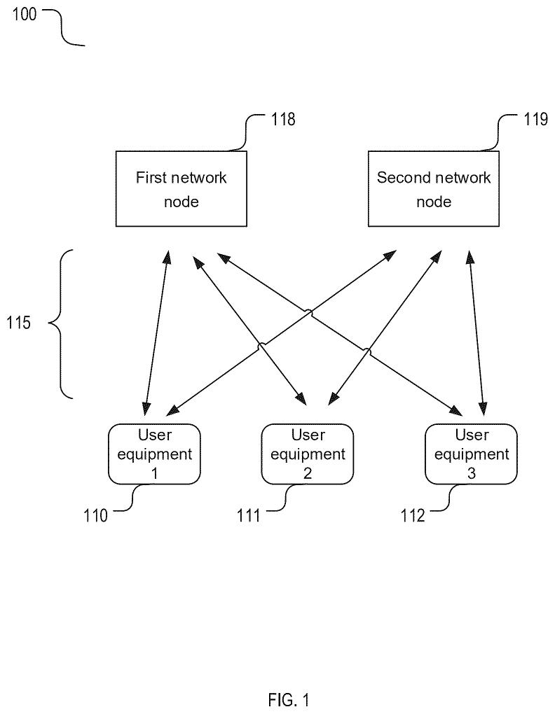

FIG. 1 shows a wireless communication system 100 including more than one network nodes (118 and 119) and one or more user equipment (UE) (110, 111, and 112). In some implementations, the two network nodes (118 and 119) may from two different networks, or may from a same network.

For the 5th Generation mobile communication technology, a UE 110, for example, a smart phone, may have a single subscriber identity module (SIM) or multiple subscriber identity modules (Multi-SIMs). When the UE has a single SIM, the UE may connect to one network node 118, for example, a radio access network (RAN) node and/or a core network (CN) node, or may connect to more than one network nodes (118 and 119), for example, two RAN nodes and/or two CN nodes. When the UE has Multi-SIMs, the UE may connect to more than one network nodes (118 and 119), for example, two RAN nodes, two CN nodes, and/or one RAN node and one CN node.

The wireless network node (118 and 119) may include a network base station, which may be a nodeB (NB, e.g., eNB, or gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time or simultaneously at the same time, the first UE 110 may wirelessly communicate with the second network node 119 via a channel including a plurality of radio channels.

The present disclosure describes various embodiments for user equipment (UE) capability coordination in dual-connection (DC) for one, some, or all of the scenarios as described in the present disclosure. The present disclosure describes methods, systems, and storage medium of how the UE coordinates temporary UE capability restriction (e.g., UE capability restriction information) to one or more network (or network node), and/or how one or more network node coordinate temporary UE capability restriction (e.g., UE capability restriction information) to other network nodes and/or to the UE.

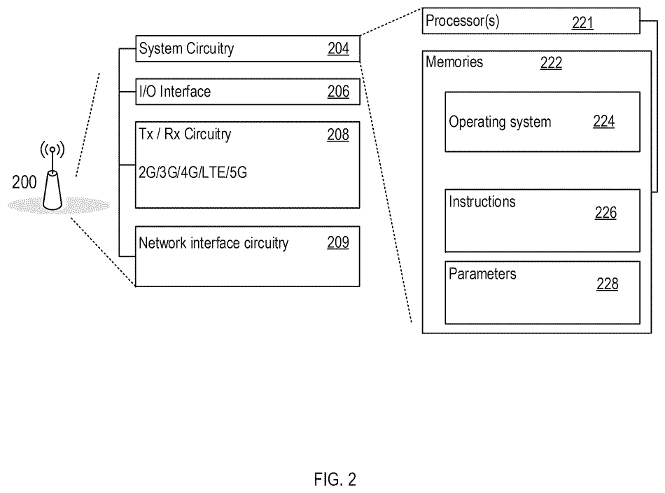

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

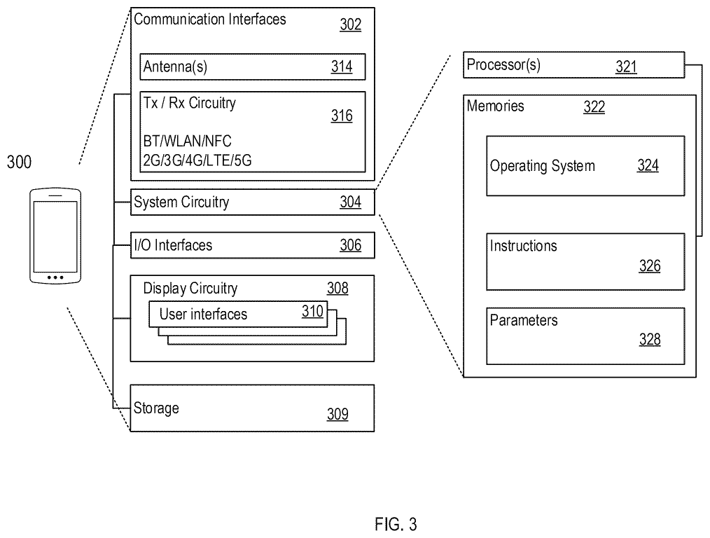

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310.

The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and/or further developed standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

In some implementations, for MUSIM enhancement, MUSIM UE's hardware capabilities are shared by the SIMs, and to use the hardware efficiently and economically, the related capabilities need to be dynamically split between the two SIMs. This may lead to a temporary hardware conflict. For example, UE is connected to the network A, it would have some capability restriction to the network A when the UE need to enter connected state with the network B. Thus, the UE need to indicate the capability restriction to the network A.

In some implementations, in the master node-secondary node (MN-SN) coordination, the capability coordination may be performed by the MN indicating the available band combination (BC) information to the SN as below (MN->SN).

| | |
|---|---|
| BandCombinationInfoList ::= | SEQUENCE (SIZE (1..maxBandComb)) OF |

BandCombinationInfo

| | |
|---|---|
| BandCombinationInfo ::= | SEQUENCE { |
| bandCombinationIndex | BandCombinationIndex, |
| allowedFeatureSetsList | SEQUENCE (SIZE (1..maxFeatureSetsPerBand)) OF |

FeatureSetEntryIndex
}

| | |
|---|---|
| selectedBandEntriesMNList | SEQUENCE (SIZE (1..maxBandComb)) OF |

SelectedBandEntriesMN

| | |
|---|---|
| SelectedBandEntriesMN ::= | SEQUENCE (SIZE (1..maxSimultaneousBands)) OF |

BandEntryIndex

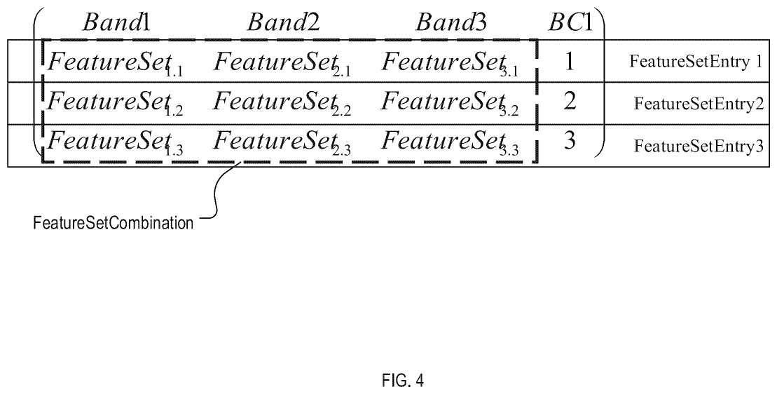

In the above, the MN may indicate to the SN about the available BC, selected band entries and featureSet entries for each BC. For example, referring to FIG. 4, for BC1, there are 3 bands (e.g., Band 1, Band 2, and Band 3), and also 3 feature set entries (e.g., FeatureSetEntry 1, FeatureSetEntry 2, and FeatureSetEntry 3) in the corresponding FeatureSetCombination.

In some implementations, for the BC1, when only the FeatureSetEntry 1 and FeatureSetEntry 3 can be used by the SN, the MN may set the allowedFeatureSetsList=[1][2], representing FeatureSetEntry 1 and FeatureSetEntry 3, for the BC1.

In some implementations, for the BC1, when the MN selects band 1 and band 2, the MN would set the SelectedBandEntriesMN=[0][1], representing band 1 and band 2, for the BC1.

In some implementations, from the MUSIM UE RF perspective, when it works at dual connected state with 2 USIM, it would be similar to the MR-DC, thus the similar capability coordination scheme can be considered. For example, the UE indicates the allowed BC and corresponding Feature set entry(s), the UE may also indicate forbidden BC or forbidden FeatureSet. With these implementations, the UE may provide the network with comprehensive capability restriction information.

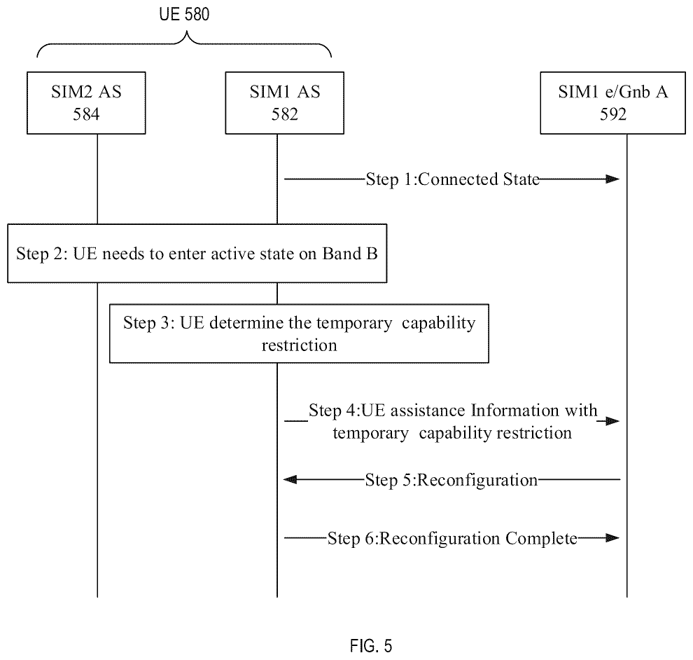

In some implementations, referring to FIG. 5, a UE (580) may report assistance information of capability restriction to the network by using a procedure. The UE may include a SIM1 access stratum (AS) 582 and a SIM2 AS 584, which are configured to connect to a SIM1 e/gNB A 692. The procedure may include a portion or all of the following steps. Step 1, the UE (SIM1 AS) is in a connected state via band A with the SIM 1 e/gNB A. Step 2, the UE needs to enter active state on band B. Step 3, the UE determines the temporary capability restriction. Step 4, the UE sends the UE assistant information with temporary capability restriction to the SIM 1 e/gNB A. Step 5, the SIM 1 e/gNB A sends a reconfiguration message to the UE. Step 6, the UE sends a reconfiguration complete to the SIM 1 e/gNB A.

In some implementations, the UE may indicate the temporary capability restriction, including one or more of the following: allowed/forbidden BC or feature set or the maximum multiple input multiple output (MIMO) layer, maximum CC numbers as the power saving/overheating, or SCell/SCG release, in the UE assistant information (UAI). The temporary capability restriction including capability update, release of cells, and/or (de)activation of configured resources and so on. The UE may indicate such restriction with band combination information.

In some implementations, in a UE capability structure, a band combination list would be reported, for each BC, there would be a FeaturesetCombination. For each FeaturesetCombination, there may be one or more featureset combinations, take the BC1 as below as an example (e.g., FIG. 4), there are 3 featureset combination entries. For example, BC1->FeaturesetCombination ID index (or number (No.)).

In some implementations, for reporting temporary capability restriction, the UE may indicate at least one of the below BC list: an allowed BC list: the BC with the corresponding Feature set capability can be used without any restriction; an affected BC list: there are some restriction on these BCs, and/or a forbidden BC list: these BCs are forbidden.

In some implementations, for the Affected BC list, the UE may further indicate the affected featureset combination entry Entries. The featureset combination entry may include at least one of the following: an allowed featureset combination entry list: the featureset combination entry with the corresponding Feature set capability can be used without any restriction; an affected featureset combination entry list: there are some restriction on these featureset combination entries; and/or an forbidden featureset combination entry list: these featureset combination entries are forbidden.

For an non-limiting example, when, for the BC1, the UE may only support feature set combination entry 1 and 3, the UE may indicate forbidden feature set combination entry 2 into the forbidden feature set entry list for the BC1, or the UE may indicate feature set combination entry 1 and 3 into the allowed feature set entry list to the network.

In various embodiments, methods are described to address at least one of the following issues. One issue includes, for each BC, how to indicate the related feature set entry, especially for the situations wherein only fallback capability is supported. Another issue includes how to indicate the selected band entry, how to indicate the band entry of the second network (network B), or how to indicate the allowed band entry of the first network (network A). Another issue includes how to indicate the capability restriction with an inter-node message (INM).

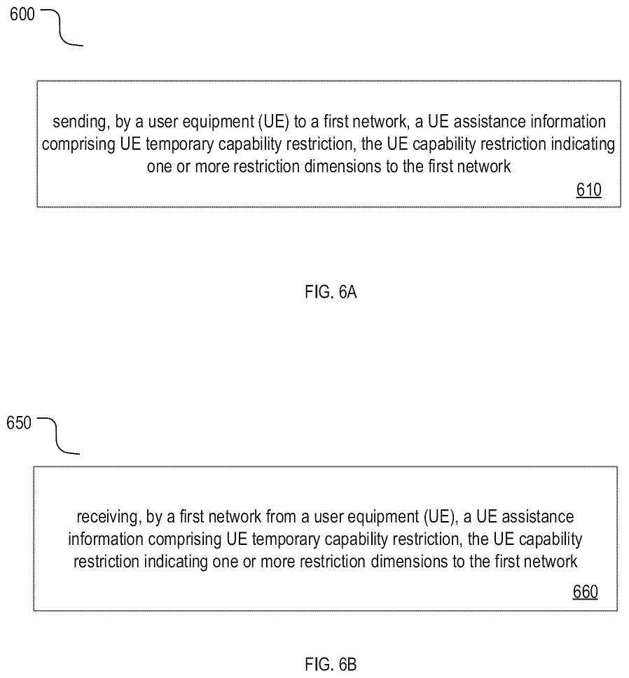

Referring to FIG. 6A, the present disclosure describes embodiments of a method 600 for wireless communication. The method 600 may include step 610, sending, by a user equipment (UE) to a first network, a UE assistance information comprising UE temporary capability restriction, the UE capability restriction indicating one or more restriction dimensions to the first network.

Without limitation to the present disclosure, the various embodiments described below may use a UE with the Multi-SIMs. These embodiments are examples and do not limit the present disclosure, and the present disclosure may also be applied to the other scenarios that a UE need to connect to two networks simultaneously or a UE is to be configured to connect to two networks simultaneously.

In some implementations, in additional to a portion or a combination of implementations or embodiments described in the present disclosure, the one or more UE capability restriction dimensions comprise restriction to each other.

In some implementations, in additional to a portion or a combination of implementations or embodiments described in the present disclosure, the UE comprises multiple universal subscriber identification modules (Multi-USIMs) corresponding to a first subscription of the first network and a second subscription of a second network.

In some implementations, in additional to a portion or a combination of implementations or embodiments described in the present disclosure, the UE temporary capability restriction comprises restriction information at a granularity level; and/or the granularity level comprises at least one of the following: per UE level, per band level, per band combination (BC) level, per band per BC level, per feature-set entry per band level, or per carrier component per BC level.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list, and/or the second dimension comprises a set of parameter limitations at the granularity level, and/or the set of parameter limitations comprises at least one of the following: a maximum multiple input multiple output (MIMO) layer, a maximum modulation order, or a maximum supported bandwidth.

In some implementations, in additional to a portion or a combination of implementations or embodiments described in the present disclosure, the affected BC reporting further comprises a feature-set entry list corresponding to at least one BC or part of at least one BC in the affected BC list, and/or the feature-set entry list comprises at least one of the following: an allowed feature-set entry, an affected feature-set entry, or a forbidden feature-set entry.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list for the UE, and/or the second dimension comprises a set of parameter limitations for the UE; and/or the UE determines a set of supported parameters by: for each parameter in the supported parameters, using a lower UE capability between the affected BC reporting and the set of parameter limitations for the UE.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list with a feature-set entry list, and/or the second dimension comprises a set of parameter limitations for each band; and/or the UE determines a set of supported parameters by: for each parameter in the supported parameters, using a lower UE capability between the affected BC reporting and the set of parameter limitations for the band.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list with a feature-set entry list, and/or the second dimension comprises a set of parameter limitations for each BC or part of each BC in the affected BC list; and/or the UE determines a set of supported parameters by: for each parameter in the supported parameters, using a lower UE capability between the affected BC reporting and the set of parameter limitations for each BC or part of each BC.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list with a feature-set entry list, and/or the second dimension comprises a set of parameter limitations for each band of each BC or part of each BC in the affected BC list; and/or the UE determines a set of supported parameters by: for each parameter in the supported parameters, using a lower UE capability between the affected BC reporting and the set of parameter limitations for each band of each BC or part of each BC.

In some implementations, in additional to a portion or a combination of implementations or embodiments described in the present disclosure, the affected BC list comprises at least one of the following: an allowed BC or a forbidden BC; and/or each band in the affected BC list is represented by at least one of the following: a band number, an absolute radio frequency channel number (ARFCN) value, or an index, wherein the index indicates a position of the band in a band list in a UE capability request message.

In some implementations, in additional to a portion or a combination of implementations or embodiments described in the present disclosure, the UE indicates at least one of the following to the first network: indication for at least one selected band entry of the second network, and/or indication for at least one allowed band entry of the first network.

Referring to FIG. 6B, the present disclosure describes embodiments of a method 650 for wireless communication. The method 650 may include step 660, receiving, by a first network from a user equipment (UE), a UE assistance information comprising UE temporary capability restriction, the UE capability restriction indicating one or more restriction dimensions to the first network.

In some implementations, in additional to a portion or a combination of implementations or embodiments described in the present disclosure, the one or more UE capability restriction dimensions comprise restriction to each other.

In some implementations, in additional to a portion or a combination of implementations or embodiments described in the present disclosure, the UE comprises multiple universal subscriber identification modules (Multi-USIMs) corresponding to a first subscription of the first network and a second subscription of a second network.

In some implementations, in additional to a portion or a combination of implementations or embodiments described in the present disclosure, the UE temporary capability restriction comprises restriction information at a granularity level; and/or the granularity level comprises at least one of the following: per UE level, per band level, per band combination (BC) level, per band per BC level, per feature-set entry per band level, or per carrier component per BC level.

In some implementations, in additional to a portion or a combination of implementations or embodiments described in the present disclosure, the UE temporary capability restriction comprises a first dimension and a second dimension, wherein: the first dimension comprises an affected BC reporting corresponding to an affected BC list, the second dimension comprises a set of parameter limitations at the granularity level, and the set of parameter limitations comprises at least one of the following: a maximum multiple input multiple output (MIMO) layer, a maximum modulation order, or a maximum supported bandwidth.

In some implementations, in additional to a portion or a combination of implementations or embodiments described in the present disclosure, the affected BC reporting further comprises a feature-set entry list corresponding to at least one BC or dimension of at least one BC in the affected BC list, and the feature-set entry list comprises at least one of the following: an allowed feature-set entry, an affected feature-set entry, or a forbidden feature-set entry.

In some implementations, in additional to a portion or a combination of implementations or embodiments described in the present disclosure, the first network receives, from the UE, at least one of the following: indication for at least one selected band entry of the second network, and/or indication for at least one allowed band entry of the first network.

In some implementations, in additional to a portion or a combination of implementations or embodiments described in the present disclosure, the first network comprises a master node and a secondary node; and/or the master node sends capability coordination information to the secondary node, the capability coordination information comprising a list of selected band entries, wherein the list of selected band entries comprises a list of band entries selected by the master node and by the second network.

In some implementations, in additional to a portion or a combination of implementations or embodiments described in the present disclosure, the capability coordination information further comprises a set of parameter limitations corresponding to the list of affected band combinations, and/or the parameter limitations comprise at least one of the following: a maximum multiple input multiple output (MIMO) layer, a maximum modulation order, or a maximum supported bandwidth.

In some implementations, in additional to a portion or a combination of implementations or embodiments described in the present disclosure, the capability coordination information further comprises a set of parameter limitations at a granularity level; and/or the granularity level comprises at least one of the following: per UE level, per band level, per band combination (BC) level, per band per BC level, per feature-set entry per band level, or per carrier component per BC level.

The present disclosure describes various exemplary embodiments for user equipment (UE) capability coordination in dual-connection (DC), which serve as examples and do not impose any limitation on the present disclosure.

### Embodiment Set I

The present disclosure describes various embodiments, wherein, for each BC, various methods may indicate the allowed feature set entry, including but not limited to, the situations wherein only fallback capability is supported.

The various embodiment may address the problem as described below. At a first network (network A) side, during the registration procedure, the network will ask the UE to report the UE capabilities. During this procedure, the network may include a frequency list in the UE capability require message, and then, the UE may report the supported band combinations according to this frequency list. According to whether a band of a second network (network B) is included in this list, there may be two cases/situations: Case 1, Network B's band (e.g., Band Z) is included in the required frequency list at network A; and Case 2, Network B's band (e.g., Band Z) is not included in the required frequency list at network A. The two cases may be represented as below.
Case 1: Band Z is required at network A
Network A: BandListFilter: Band X/Y/Z/O/P

UE reports related BCs, in which the bandcombination with band Z as BC 1˜4 as below:

$$\begin{matrix}BC 1 : X + Y + Z \\ BC 2 : X + O + Z \\ BC 3 : P + Y + Z \\ BC 4 : O + P + Z\end{matrix}$$

Case 2: Band Z was not required at network A
Network A: BandListFilter: Band X/Y/O/P

UE reports related BCs as below:

$$\begin{matrix}BC 1 : X + Y \\ BC 2 : X + O \\ BC 3 : P + Y \\ BC 4 : O + P\end{matrix}$$

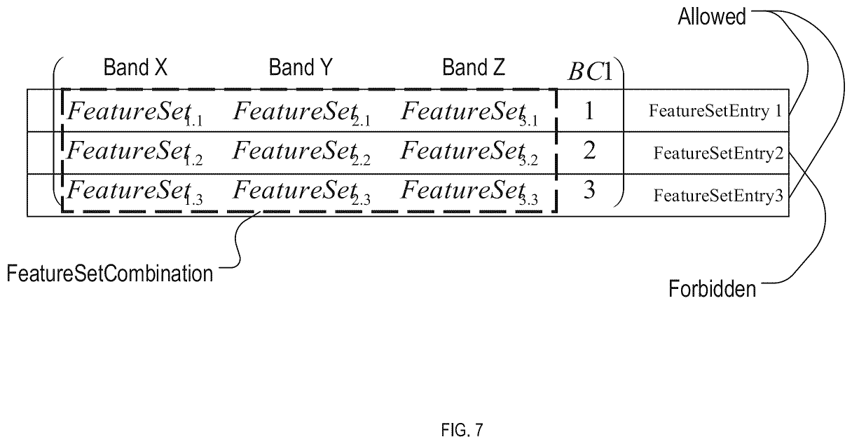

For the Case 1, the BCs with band Z and also the corresponding feature set combinations may be reported in the UE capability information. Taking BC1 as an example, BC1 includes X+Y+Z, and the UE reports the featuresetCombination for the BC1 as shown in FIG. 7. Then for the BC1, when the UE has some temporary capability restriction at network A (e.g., due to the action of the network B), the UE may indicate the BC1 together with the featureset Entry (e.g. allowed featureset Entry 1/3, or forbidden feature set Entry 2).

For the case 2, when the band Z is not included in the required frequency list, the UE may not report the BC with the band Z. In some implementations, there may be the following sub-cases.

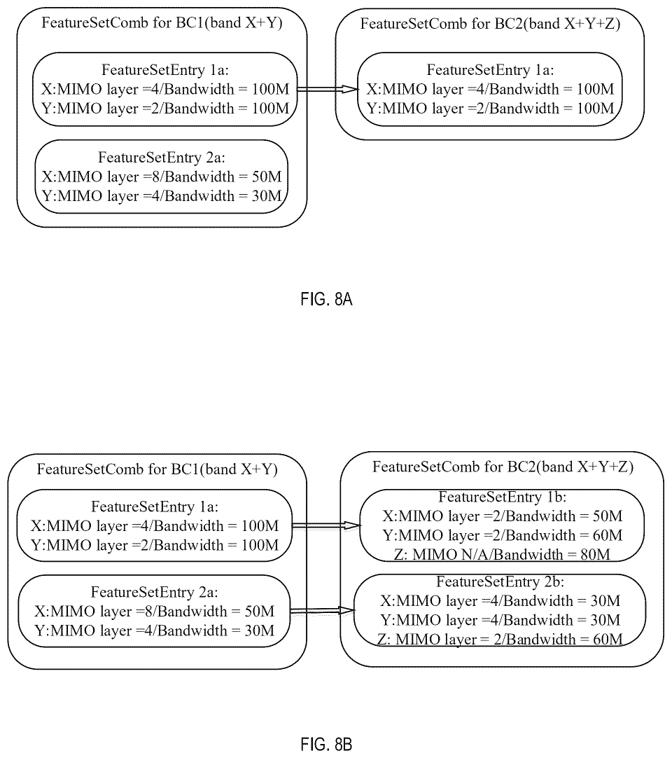

Sub-case 1: The UE can support the original Featureset Entry in the FeaturesetCombination for the BC without Band Z. For a non-limiting example, referring to FIG. 8A, when the UE reported the BC1 with featureSetCombination (include both FeatureSetEntry 1a/2a) to the network A, and when the UE connects with network B with band Z, the UE may support FeatureSet Entry 1a at band X+Y, and then the UE may indicate BC1 with feature Set Entry la to the network A as temporary capability restriction.

Sub-case 2: The UE may only support the fallback Featureset. In some implementations, this sub-case may occur when the Band of the network B is not included in the network required band list. For a non-limiting example, referring to FIG. 8B, when the UE reported the BC1 with featureSetCombination (include both FeatureSetEntry 1a/2a) to the network A, and when the UE connects with network B with band Z, the UE may only support lower capabilities than (or fallback capabilities of) the reported original featuresetCombination Entry. For example, for the featureSetEntry 1a, it may support bandwidth 100 MHz at band X with MIMO layer 4; but when the UE work at band Z simultaneously, the UE may only support bandwidth 50 MHz with MIMO layer 2. Various implementations may be used to indicate the supported temporary capabilities restriction for the band X+Y.

In various embodiments, the UE may indicate some other critical limitation (e.g. maximum MIMO layer, maximum modulation order, supported bandwidth, etc.) to these affected BC list or to each BC or to part of the BCs that included in the affected BC list. The temporary capability restriction may include a portion or all of the following: allowed, affected, and/or forbidden BC information; allowed, affected, and/or forbidden featureset combination entry list; and/or dedicated capability parameters limitation (e.g. maximum MIMO layer, maximum modulation order, supported bandwidth, etc.). The dedicated capability parameters limitation may be set at various granularity level, for example but not limited to, for all BC, for each BC, for part of the BC, for each feature set combination entry of each BC, for UE, for band. These dedicated parameters can also be reported for the UL and DL separately with the above granularity.

In some embodiments, the UE may perform BC reporting together with some capability restriction. In other words, these dedicated capability parameters can be used to indicate the fallback capabilities, one or more of the following parameters may be reported at various granularity level.

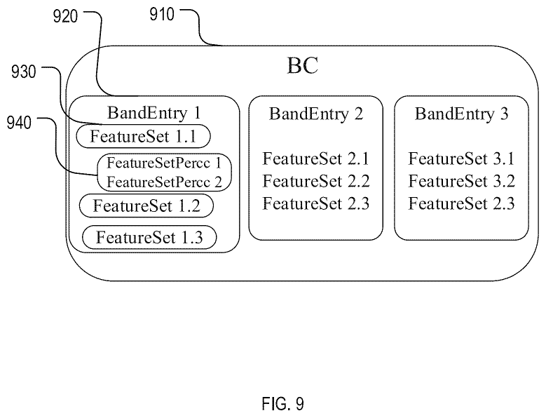

For non-limiting example, referring to FIG. 9, the dedicated capability report level includes at least one of per BC (910), per band per BC (920), per FeaturesetEntry per band (930), or per carrier component (cc) per BC (940).

In some implementations, the dedicated capability may be reported at per UE level, so that all the BC shall respect to these UE level restrictions.

In some implementations, the dedicated capability may be reported at per band level, so that all the related band in each BC shall respect to these band level restrictions.

Some non-limiting examples for the per UE level reporting are described below. For the per UE level reporting, the temporary capability restriction may include 2 parts (or two dimensions), wherein each part/dimension may apply restriction on the other part/dimension. A first part/dimension (Part 1 or Dimension 1) may include affected BC list (including allowed and/or forbidden BC list), and/or related one or more FeatureSetEntry. A second part/dimension (Part 2 or Dimension 2) may include dedicated parameters per UE (e.g. maximum MIMO layer, maximum modulation order, supported bandwidth, etc.). The supported MIMO layer/modulation order/bandwidth may be determined by the lower capability between the Part 1 and Part 2. For example, for MIMO layer, when the part 1 includes a MIMO layer of 4 and the part 2 include a maximum MIMO layer of 2, the supported MIMO layer is determined as 2, because MIMO layer of 2 is the lower capability between MIMO layer of 4 and MIMO layer of 2.

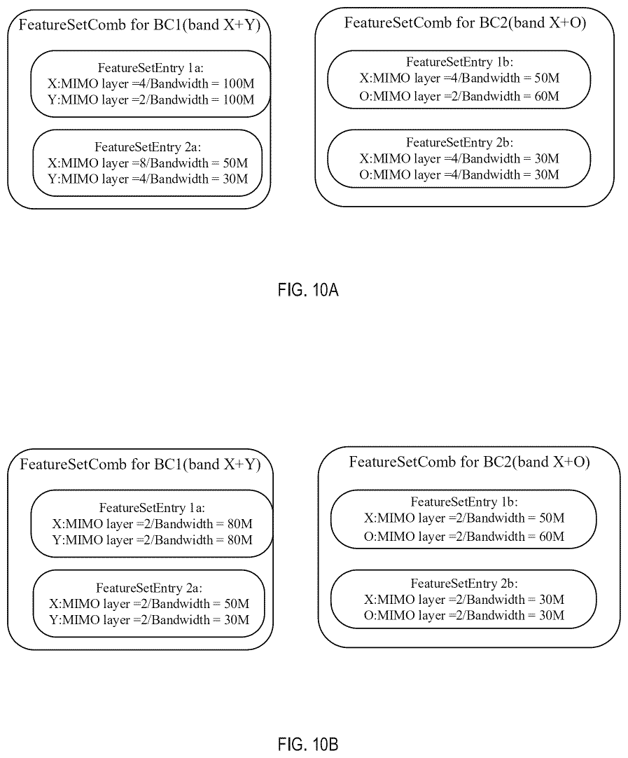

For an example of per UE level reporting, referring to FIG. 10A, Part 1 includes affected BC reporting, and Part 2 includes maximum MIMO layer=2, maximum bandwidth per band=80 MHz. In some implementations, maximum bandwidth may be reported as being per CC=80 MHz. In the figures in the present disclosure, the “M” for the bandwidth refer to “MHz”.

FIG. 10B shows the final supported capability, as being determined by the lower capability between the Part 1 and Part 2.

Some non-limiting examples for the per band level reporting are described below. For the per band level reporting, the temporary capability restriction would include 2 parts (or two dimensions), wherein each part/dimension may apply restriction on the other part/dimension. A first part/dimension (Part 1 or Dimension 1) may include affected BC list (including allowed or forbidden BC), which may also include the related one or more FeatureSetEntry. A second part/dimension (Part 2 or Dimension 2) may include dedicated parameters per band (e.g. maximum MIMO layer, maximum modulation order, supported bandwidth, etc.). The supported MIMO layer/modulation order/bandwidth may be determined by the lower capability between the part 1 and part 2.

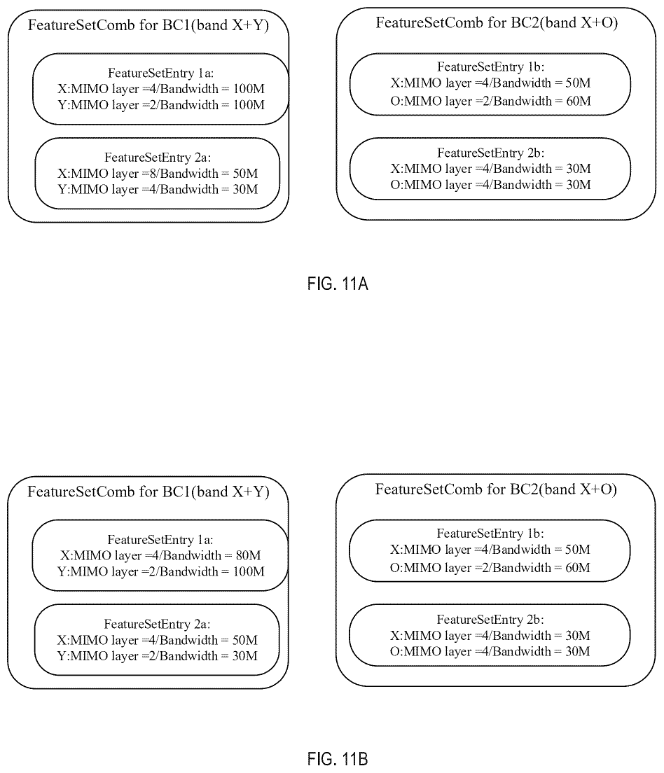

For an example of per band level reporting, referring to FIG. 11A, Part 1 includes affected BC reporting, and Part 2 includes: for Band X, Max MIMO layer=4, bandwidth per band (or per CC)=80 MHz; for Band Y, Max MIMO layer=2; and for Band O, no restriction.

FIG. 11B shows the final supported capability, as being determined by the lower capability between the Part 1 and Part 2.

Some non-limiting examples for the per BC level reporting are described below. For the per BC level reporting, the temporary capability restriction may include 2 parts (or two dimensions), wherein each part/dimension may apply restriction on the other part/dimension. A first part/dimension (Part 1 or Dimension 1) may include affected BC list (including allowed or forbidden BC), and may also include the related one or more FeatureSetEntry, which may be reported by index according to the reported UE capability information, e.g., Index 1 corresponding to the first BC that reported in the supported BC list in the UE capability.

A second part/dimension (Part 2 or Dimension 2) may include, for each affected BC (or part of BCs), dedicated parameters (e.g. maximum MIMO layer, maximum modulation order, supported bandwidth, etc.). The supported MIMO layer/modulation order/bandwidth may be determined by the lower capability between the Part 1 and Part 2.

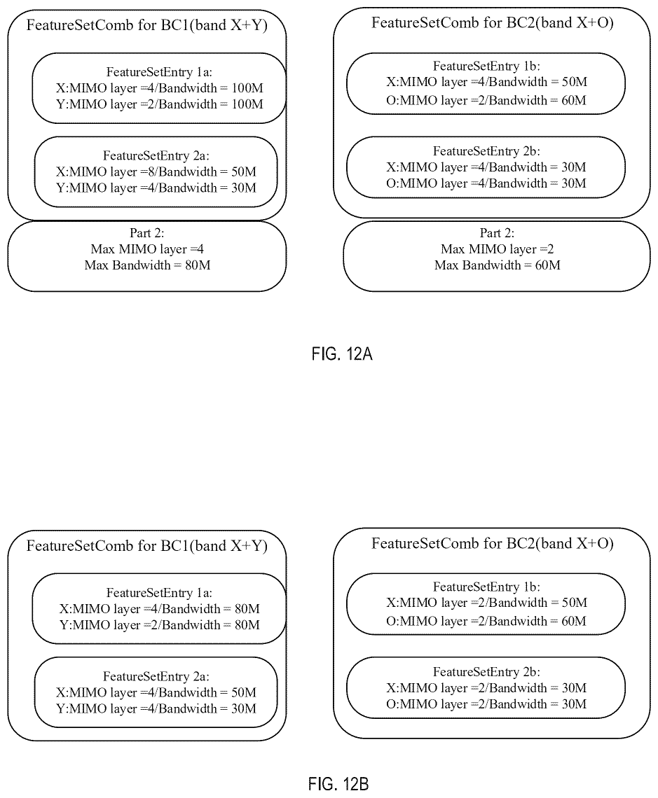

For an example of per BC level reporting, referring to FIG. 12A, Part 1 includes affected BC reporting, and Part 2 includes some dedicated parameters.

FIG. 12B shows the final supported capability, as being determined by the lower capability between the Part 1 and Part 2.

Some non-limiting examples for the per band per BC level reporting are described below. For the per BC level reporting, the temporary capability restriction may include 2 parts (or two dimensions), wherein each part/dimension may apply restriction on the other part/dimension. A first part/dimension (Part 1 or Dimension 1) may include affected BC list (including allowed and/or forbidden BC), and may also include the related one or more FeatureSetEntry, which may be reported by index according to the reported UE capability Information, e.g. Index 1 corresponding to the first BC that reported in the supported BC list in the UE capability. A second part/dimension (Part 2 or Dimension 2) may include, for each band of each affected BC (or part of BCs), dedicated parameters (e.g. maximum MIMO layer, maximum modulation order, supported bandwidth, etc.). The supported MIMO layer/modulation order/bandwidth may be determined by the lower capability between the Part 1 and Part 2.

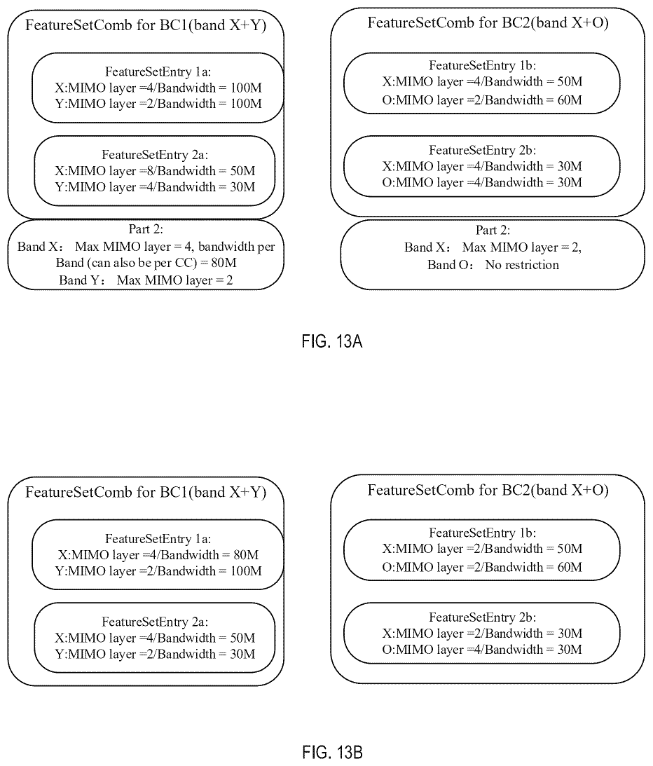

For an example of per band per BC level reporting, referring to FIG. 13A, Part 1 includes affected BC reporting, and Part 2 includes some dedicated parameters.

FIG. 13B shows the final supported capability, as being determined by the lower capability between the Part 1 and Part 2.

The various embodiments/implementations in the present disclosure may be applicable similarly to capability restriction reporting at other levels, including but not limited to, per FeaturesetEntry per band, and/or per cc per BC, wherein the similar logic flow may be used with one of the differences being that the dedicated parameters are reported with more granularity.

In various embodiments/implementations described in the present disclosure, each BC in the affected BC list may be indicated by an index, which indicates the position of a band combination in the supported band combination list that included in the UE capability reporting. As an enhancement, when the network configures the UE to report MUSIM assistance information, it may also include one or more frequency band information (e.g. with a band number or an absolute radio frequency channel number (ARFCN) value).

For a non-limiting example, in a MUSIM assistance information reporting configuration, a Reconfiguration->OtherConfig->MusimConfig->Bandlist may include Bandlist[0]=Nx, Bandlist[2]=Ny, and/or Bandlist[2]=Nz, wherein Nx, Ny, and/or Nz are non-negative integers.

In some implementations, other than using the band number or the ARFCN value, it may also be indicated by an index, which indicates the position of a band that included in the bandlist of the UE capability require message. When the UE report the affected BCs, the UE may only indicate the BC that includes the band that configured by the network (e.g. when the network configures the UE to report the MUSIM assistance information).

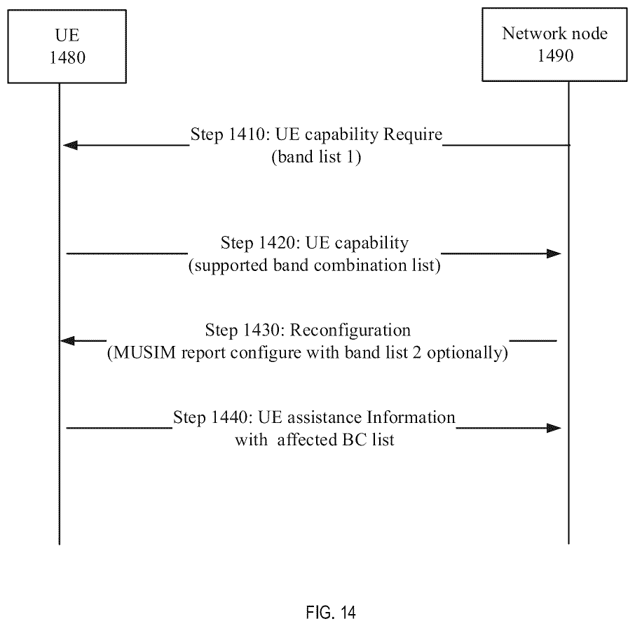

For one non-limiting example, referring to FIG. 14, a method may include a portion or all of the following steps.

Step 1410: A network (1490) configures a UE (1480) to report UE capability with a band list (e.g. including band x, band y, band z, band o, and band p).

Step 1420: The UE reports the UE capability with supported BC list, the supported band combination are the BC composed with one or more of band (x, y, z, o, and/or p).

Step 1430: The network configures the UE to report the MUSIM assistance information, which may include a band list for the MUSIM reporting (e.g., band x, band y, band z, band o, and/or band p).

Step 1440: The UE may report a MUSIM affected BC list that only include the BC that includes band in the bandlist in the step 1430. The affected BC list can be indicated by one or more index, and each index indicates the position of a band combination in the supported band combination list that included in the UE capability reporting in the step 1420.

The present disclosure describes various exemplary embodiments for UE capability coordination in dual-active state, which serve as examples and do not impose any limitation on the present disclosure.

### Embodiment Set II

The present disclosure describes various embodiments, wherein, for each BC, various methods may indicate one or more selected band entry, for example but not limited to, indicating the one or more band entry of the network B, or indicating the one or more allowed band entry of the network A.

The various embodiment may address the problem as described below. For the cases described above: Case 1: Network B's band (e.g., Band Z) is included in the required frequency list at network A; and Case 2: Band Z is not included in the required frequency list at network A. The two cases may be represented as below.
Case 1: Band Z is required at network A
Network A: BandListFilter: Band X/Y/Z/O/P

UE reports related BCs, in which the bandcombination with band Z as BC 1˜4 as below:

$$\begin{matrix}BC 1 : X + Y + Z \\ BC 2 : X + O + Z \\ BC 3 : P + Y + Z \\ BC 4 : O + P + Z\end{matrix}$$

Case 2: Band Z was not required at network A
Network A: BandListFilter: Band X/Y/O/P

UE reports related BCs as below:

$$\begin{matrix}BC 1 : X + Y \\ BC 2 : X + O \\ BC 3 : P + Y \\ BC 4 : O + P\end{matrix}$$

In some implementations, besides the affected bandlist, the network A also need to know which bands are allowed for the network A side. For the above case 2, only network A bands are included, but for the case 1, the bands of both networks are included in each BC.

Various embodiments provides methods for determining which bands are allowed at network A, and the method may include at least one of the below two options. For option A, the UE indicates the selected band entry of the network B; and for option B, the UE indicates the allowed band entry of the network A.

For a non-limiting example, the UE works at band Z with network B, and Band X+Y for the network A.

For option A, for Case 1, the UE indicates the band Z as the selected band Entry; or for Case 2, the UE may not indicate any band because there is no BC include band entry Z.

For option B, for Case 1, the UE may indicate band X+Y (or other band entry that can work together with band Z), for example the allowed band entry may include BC1: X+Y, BC2: X+O, BC3: P+Y, and/or BC4: O+P. For Case 2, the allowed band entry may include BC1: X+Y, BC2: X+O, BC3: P+Y, and/or BC4: O+P, wherein, in some implementations, there are also cases that part of BC are reported as fallback of the other BC. For example, the UE doesn't report BC1, instead it report BC 5: X+Y+O, and then the UE can indicate the BC5 with allowed band entry X and Y.

### Embodiment Set III

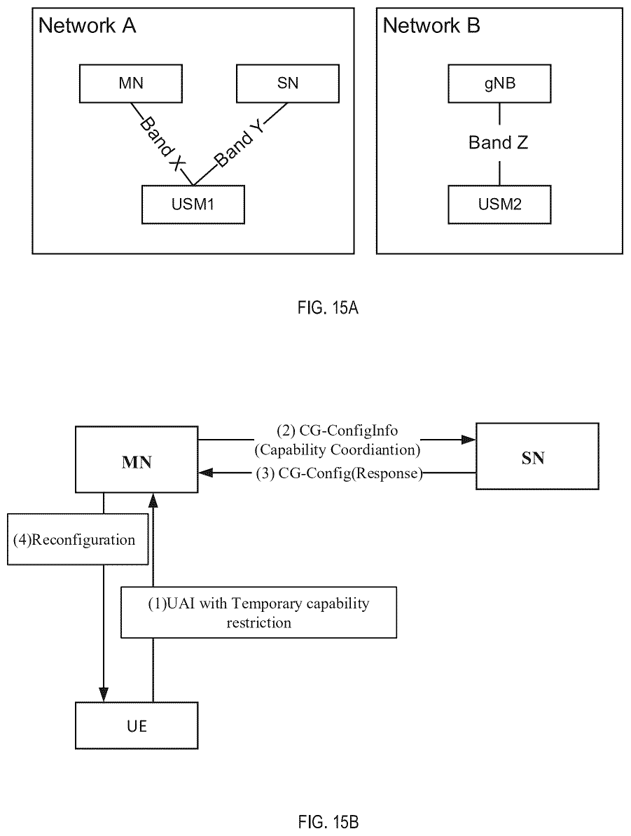

The present disclosure describes various embodiments that may address the problem as described below. Referring to FIG. 15A, with multiple-radio access technology (Multi-RAT) (MR) dual connectivity (DC) (MR-DC) structure, a master node (MN) may indicate the select band entry at the MN side to a secondary node (SN), and then the SN may further select SN sides band. As described in the present disclosure, when the UE reports a BC that includes both the network A and the network B side, and when the network A is working at MR-DC structure, there are issues/problems associate with how the MN indicates the band entry information to the SN, and/or how the MN indicates the featureset related restriction to the SN. Referring to FIG. 15B, Step 1: the UE indicates the temporary capability restriction (e.g., affected BC list, affect feature set entry per BC, dedicated capability parameters, etc.); Step 2: the MN determine the allowed BC list and selectedBandEntriesMNList; Step 3: the SN give a response to the MN; and/or Step 4: the MN send the reconfiguration to the UE.

Various embodiments describe methods for band entry indication, which may address the issues/problems of, in the step 2 of FIG. 15B, how to set the selected band entry by the MN, and/or how to indicate the temporary capability restriction to the SN. In the methods, both the selected band entry by the MN and the other network (e.g., network B) may be included in the SelectedBandEntriesMN, as shown below (MN->SN).

| | |
|---|---|
| BandCombinationInfoList ::= | SEQUENCE (SIZE (1..maxBandComb)) OF |

BandCombinationInfo

| | |
|---|---|
| BandCombinationInfo ::= | SEQUENCE { |
| bandCombinationIndex | BandCombinationIndex, |
| allowedFeatureSetsList | SEQUENCE (SIZE (1..maxFeatureSetsPerBand)) OF |

FeatureSetEntryIndex
}

| | |
|---|---|
| selectedBandEntriesMNList | SEQUENCE (SIZE (1..maxBandComb)) OF |

SelectedBandEntriesMN

| | |
|---|---|
| SelectedBandEntriesMN ::= | SEQUENCE (SIZE (1..maxSimultaneousBands)) OF |

BandEntryIndex

In the above, for the SelectedBandEntriesMN, both the selected band entry by the MN and the other network (e.g., band of the network B) shall be included.

For one non-limiting example, one case may be represented as below.
Case 1: Band Z is required at network A
Network A: BandListFilter: Band X/Y/Z/O/P

UE reports related BCs, in which the bandcombination with band Z as BC 1˜4 as below:

$$\begin{matrix}BC 1 : X + Y + Z \\ BC 2 : X + O + Z \\ BC 3 : P + Y + Z \\ BC 4 : O + P + Z\end{matrix}$$

For Case 1, taking the BC1 as an example, when the network A selects Band X at master cell group (MCG), and then the MCG may include band X and Band Z as the selected band entry at the MN side. Furthermore, the MCG may only select the featuresetEntry that allowed in the MUSIM UAI.

Various embodiments describe methods for the feature Set Entry restriction indication. For MN->SN, the MN needs to indicate the dedicated parameters limitation to the SN. The dedicated capability restriction may also be forwarded to the SCG. Taking per BC level dedicated capability restriction reporting as an example, the UE reports the allowed BC1/BC2 to the MN with per BC level dedicated capability restriction. In step 2 in FIG. 15B, the MN may also forward these dedicated capability restriction to the SN, for example, the restriction information as shown in FIG. 12A.

In all of the above solutions, the dedicated parameters can also be reported for the UL/DL separately (or only for the UL or only for the DL) with the above granularity. The parameter of the second dimension (e.g. dedicated parameters) can be any parameter that included in the first dimension (e.g. affected band combination).

### Embodiment Set IV

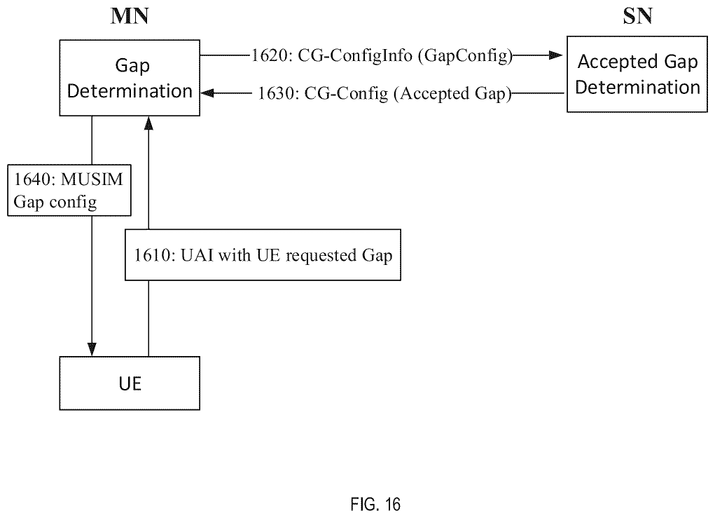

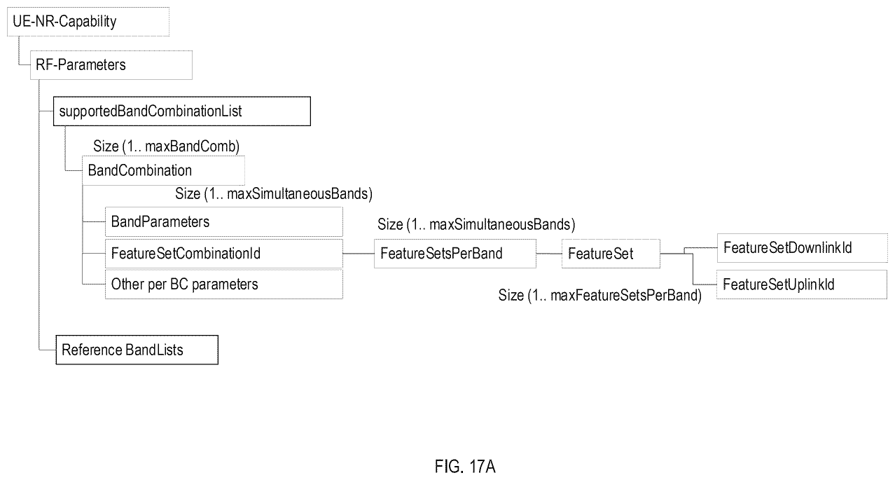

The present disclosure describes various embodiments for addressing issues related to scheduling gap. For a MUSIM UE, the UE may request multiple per UE scheduling gaps (e.g., 3 periodic gaps and 1 aperiodic gap). The network may configure the per UE gaps according to the UE's request. When UE is working at MR-DC structure at the network A, the MN need to coordinate with SN about this per UE gap, wherein the per UE gap means that it may be applied at both MN and SN side. Referring to FIG. 16, a general procedure may include a portion or all of the following steps.

Step 1610, a UE sends a UAI to a MN, and the UAI may include a gap configuration, as below.

MUSIM-Assistance-r17 ::= SEQUENCE {
musim-PreferredRRC-State-r17 ENUMERATED {idle, inactive, outOfConnected}
OPTIONAL,
musim-GapPreferenceList-r17 MUSIM-GapPreferenceList-r17 OPTIONAL
}
MUSIM-GapPreferenceList-r17 ::= SEQUENCE (SIZE (1..4)) OF MUSIM-GapInfo-r17

Step 1620, the MN determines the accepted gap request and sends it to the SN.

In the CG-ConfigInfo, there are two options. The first option may include reusing the MUSIM-GapConfig-r17 structure, which may support delta configuration, as below.

MUSIM-GapConfig-r17 ::= SEQUENCE {
musim-GapToReleaseList-r17 SEQUENCE (SIZE (1..3)) OF MUSIM-GapId-r17
OPTIONAL, -- Need N
musim-GapToAddModList-r17 SEQUENCE (SIZE (1..3)) OF MUSIM-Gap-r17
OPTIONAL, -- Need N
musim-AperiodicGap-r17 MUSIM-GapInfo-r17 OPTIONAL, -- Need N
...
}
MUSIM-Gap-r17 ::= SEQUENCE {
musim-GapId-r17 MUSIM-GapId-r17,
musim-GapInfo-r17 MUSIM-GapInfo-r17
}

The second option includes no delta configuration, as below.

MUSIM-GapConfigINM-r17 ::= SEQUENCE {
musim-PerioidcGaoList-r17 SEQUENCE (SIZE (1..3)) OF MUSIM-Gap-r17 OPTIONAL, --
Need N
musim-AperiodicGap-r17 MUSIM-GapInfo-r17 OPTIONAL, -- Need N
}

Step 1630, the SN determines the accepted gap request and sends it to the MN in the CG-Configure, as below.

MUSIM-GapConfigSCG-r17 ::= SEQUENCE {
musim-GapList-r17 SEQUENCE (SIZE (1..3)) OF MUSIM-GapId-r17 OPTIONAL, -- Need
N
musim-AperiodicGap-r17 Enum(Accepted) OPTIONAL, -- Need N
}

Step 1640, for MUSIM GAP Configuration, the MN sends the configuration to the UE, as below.

MUSIM-GapConfig-r17 ::= SEQUENCE {
musim-GapToReleaseList-r17 SEQUENCE (SIZE (1..3)) OF MUSIM-GapId-r17
OPTIONAL, -- Need N
musim-GapToAddModList-r17 SEQUENCE (SIZE (1..3)) OF MUSIM-Gap-r17
OPTIONAL, -- Need N
musim-AperiodicGap-r17 MUSIM-GapInfo-r17 OPTIONAL, -- Need N
...
}
MUSIM-Gap-r17 ::= SEQUENCE {
musim-GapId-r17 MUSIM-GapId-r17,
musim-GapInfo-r17 MUSIM-GapInfo-r17
}
MUSIM-GapInfo-r17 ::= SEQUENCE {
musim-Starting-SFN-AndSubframe-r17 MUSIM-Starting-SFN-AndSubframe-r17
OPTIONAL, -- Cond aperiodic
musim-GapLength-r17 ENUMERATED {ms3, ms4, ms6, ms10, ms20} OPTIONAL, --
Cond gapSetup
musim-GapRepetitionAndOffset-r17 CHOICE {
ms20-r17 INTEGER (0..19),
ms40-r17 INTEGER (0..39),
ms80-r17 INTEGER (0..79),
ms160-r17 INTEGER (0..159),
ms320-r17 INTEGER (0..319),
ms640-r17 INTEGER (0..639),
ms1280-r17 INTEGER (0..1279),
ms2560-r17 INTEGER (0..2559),
ms5120-r17 INTEGER (0..5119),
...
} OPTIONAL -- Cond periodic
}
MUSIM-Starting-SFN-AndSubframe-r17 ::= SEQUENCE {
starting-SFN-r17 INTEGER (0..1023),
startingSubframe-r17 INTEGER (0..9)
}
Embodiment Set V

In some implementations, for network energy savings for NR, an objective about SSB-less Cell is to specify SSB-less SCell operation for inter-band CA for FR1 and co-located cells, when found feasible by some study, where a UE measures SSB transmitted on PCell or another SCell for an SCell's time/frequency synchronization (including downlink AGC), and L1/L3 measurements, including potential enhancement on SCell activation procedures when necessary.

In some implementations, the SSB-less SCell for intra-band CA may be supported. The timing and frequency synchronization of SSB-less SCell could depend on the co-site SpCell. For TA maintenance, SSB-less SCell and co-site SpCell are in the same TAG, it may be ensured by NW implementation. For UL and DL relationship, the pathloss reference for power control of SRS, PUCCH and PUSCH in SCell may be derived from CSI-RS or SSB in SpCell via RRC configuration, and the spatial relationship of PUCCH and SRS in SCell may be derived from CSI-RS or SSB in SpCell via RRC configuration. For cross-carrier scheduling, PUSCH in SCell may be scheduled by PDCCH in SpCell. For RRM, in co-site scenario, the addition/change/release of SSB-less SCell may be performed based on the measurement results of the co-site SpCell, and this can be left to NW implementation, hence, no measurement object for SSB-less SCell could be configured. UE could obtain the timing, frequency synchronization of SSB-less SCell from the SpCell.

Regarding SSB_Less Scell Types and SSB_Less BC Types definition, for the SSB-less SCell for inter-band CA, one difference between SSB-less SCell for inter-band CA and SSB-less SCell for intra-band CA is about the UE capability reporting, e.g. introduce a new UE capability to indicate the support of inter-band SCell without SSB.

The SSB_less Scell includes the below types: Type 1: SSB-less SCell with DL resource with DL PDSCH/TRS/CSI-RS; Type 2: SSB-less SCell without TRS/CSI-RS but with PDSCH (PDSCH is configured but TRS/CSI-RS are not configured); and Type 3: SSB-less SCell without any DL resource (i.e. no DL resource is configured in RRC).

From the UE capability perspective, it means that the UE can indicate the Band Combination with the SSB_less band entry (shortly be called as SSB_less BC) implicitly or explicitly, also including 3 SSB_less band entry types, which includes at least: Type 1: one or more SSB-less band entry that support DL resource with DL PDSCH/TRS/CSI-RS; Type 2: one or more SSB-less band entry that without TRS/CSI-RS but with PDSCH; and/or Type 3: one or more SSB-less band entry that doesn't support any DL resource.

Regarding implicit way reporting (per band pair), the implicitly way means that the UE does not indicate the BC with SSB_less Band entry immediately, instead, the UE indicates a per band pair level information, then the SSB_less BC can be further determined by the normal band combination and this per band pair level information. For example, the UE indicates a potential “reference band list” for each SSB-less SCell capable band, which means that the ‘reference band list for each inter-band SSB-less SCell capable band’ is configured independently (independent from band combination), and it is applicable to all the band combination.

At the network side the inter-band SSB-less SCell can only be configured in case a serving cell with SSB on the corresponding potential ‘reference’ band is configured in the CA operation.

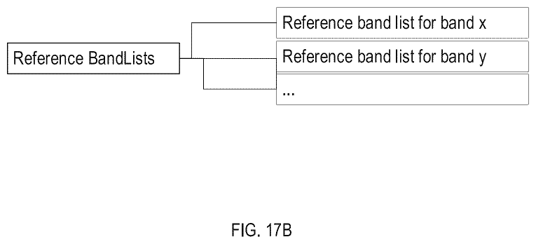

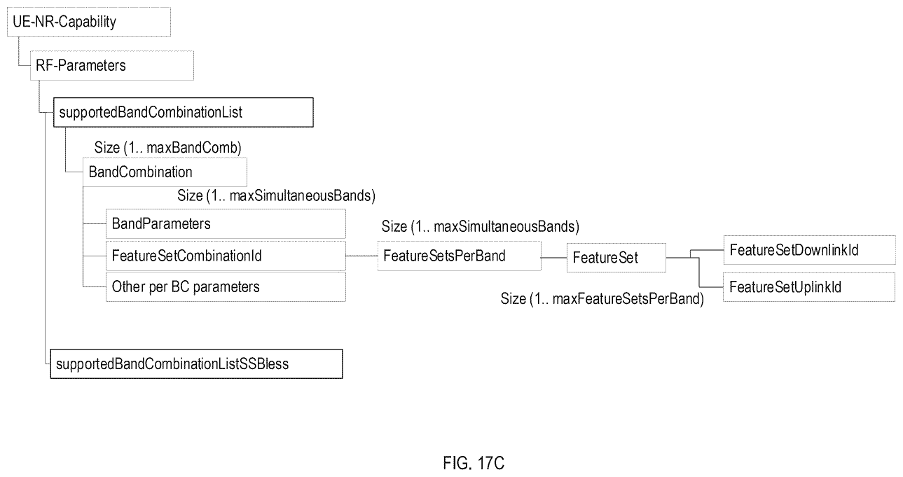

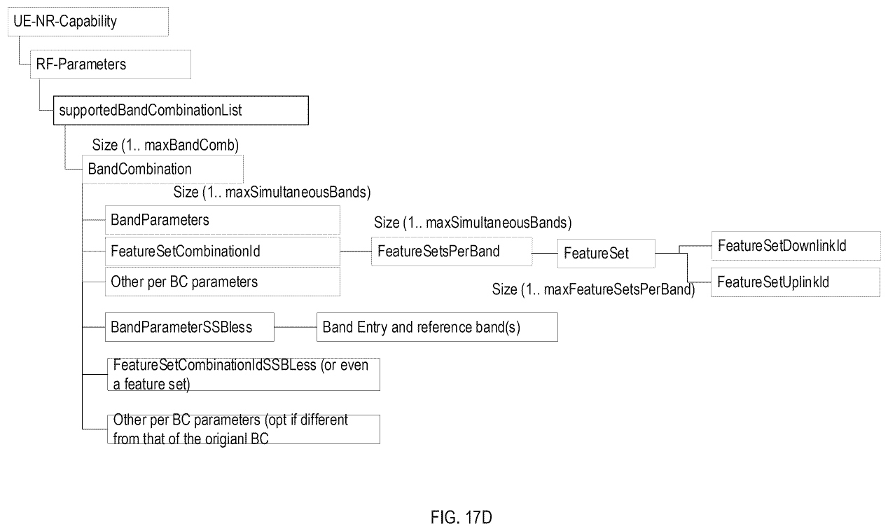

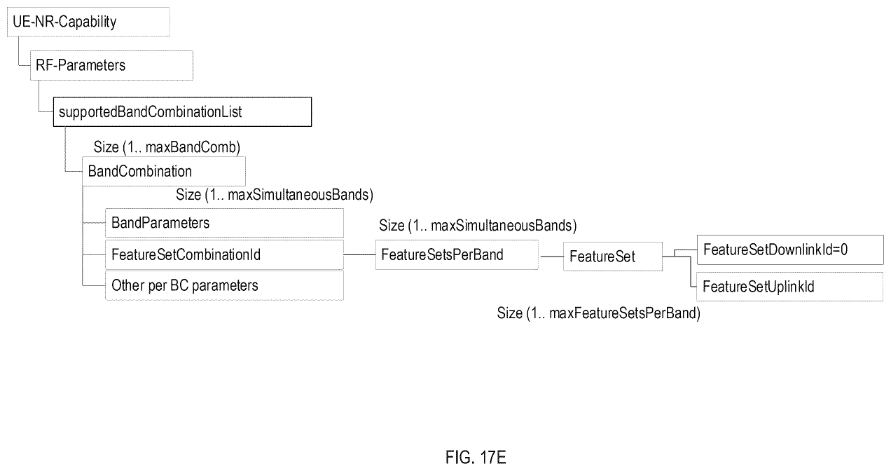

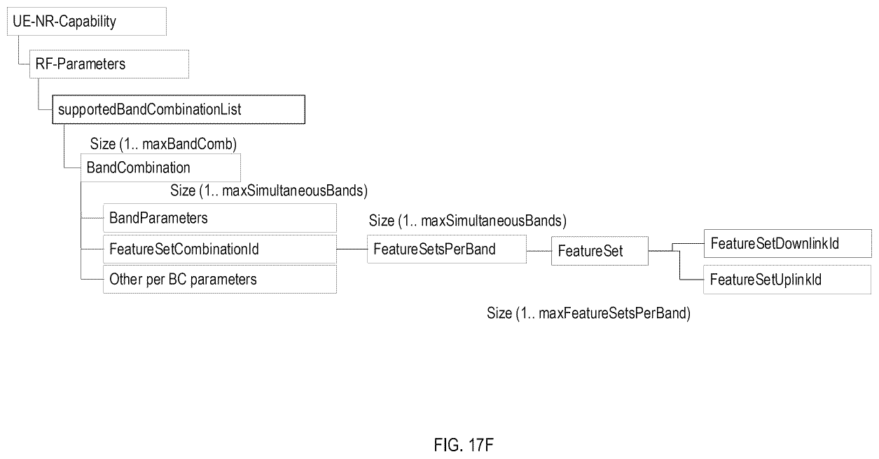

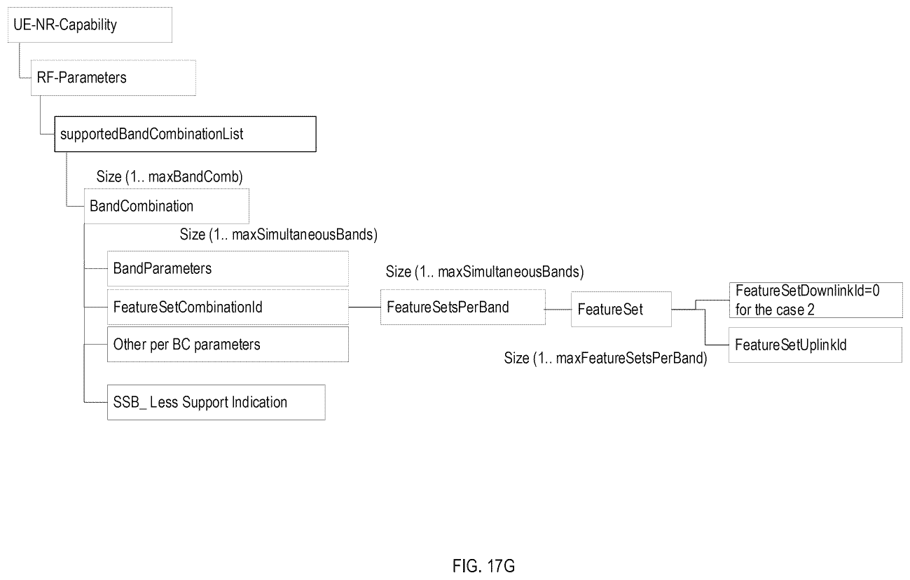

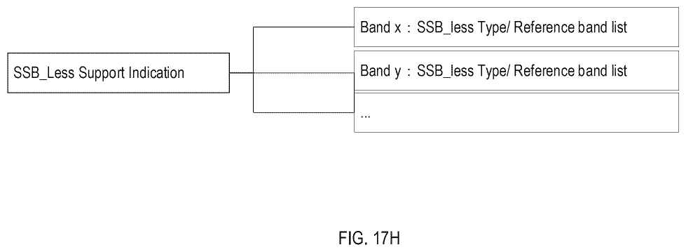

FIG. 17A shows an example of per band pair reference band list reporting.

The UE may indicate the reference band lists parallel with the supported band combination, in the reference band lists, it indicates the feasible reference band list for each SSB-less SCell capable band.

FIG. 17B shows an example of a reference band list structure.

For a non-limiting example, the UE reports 2 BC as BC1: Band A+Band B+Band C, and BC2: Band A+Band B+Band D. Furthermore, the UE also reports reference band list (Band C, Band D) for the Band B, then it means that the UE can support the below SSB_Less BC (referred as BC1a/BC2a), wherein BCla: Band A+Band B+Band C(SSB_less), and BC2a: Band A+Band B+Band D(SSB_less).

At the network side, the network can configure SSB-less SCell on the band C or band D when band B is configured in the CA operation.

In some implementations, for the reference band list, the following alternatives may be considered.

(1) For each band on which SSB-less inter-band SCell is supported, a band list is reported to indicate the band which can be used as a reference band for the SSB-less inter-band SCell. The inter-band SSB-less SCell can only be configured when, at least, one serving cell on the reference band is configured in the CA operation.

(2) For each band that can work as reference band for inter-band SSB-less SCell, a SSB-less SCell capable band list is reported to indicate the applicable band for SSB-less inter-band SCell. When one serving cell with SSB is configured on the reference band, inter-band SSB-less SCell on the applicable band list can be configured.

(3) One or multiple band list or band group is configured. The band within the same list/group can be used as a reference band for each other. When one serving cell with SSB is configured in CA operation, then inter-band SSB-less SCell can be configured on the other band of the same list/group.

In some implementations, additionally, besides the band information, SSB-less SCell type may be included in the band list/band group as well to indicate the type of SSB-less SCell supported.

Regarding explicit way reporting (per band combination), the explicit way means that the UE can indicate the supported SSB_Less BC explicitly, e.g. with the per BC granularity. The ‘reference band list for each inter-band SSB-less SCell capable band’ would be reported per BC. Generally there are 5 solutions for the explicit way.

Solution 1 includes adding a new BC list for the SSB_Less BC. FIG. 17C shows an example of a new BC list for the SSB Less BC. With this solution, the UE may indicate the supported SSB_Less BCs in a separate list, and in each SSB_Less BC, the UE further indicates a reference band list to indicate which band can be taken as reference band. At the network side, the inter-band SSB-less SCell can only be configured in case a serving cell with SSB on the corresponding potential ‘reference’ band is configured in the CA operation. Furthermore, the UE can also indicate a featruesetCombination ID and/or other parameters that are different from the basic BC.

Solution 2 includes adding one or more new band entry to the basic BC.

The one or more new band Entry can be used to indicate the SSB Less Scell capable band. For the new band entry, the UE can also indicate a reference band list to indicate which band can be taken as reference band. At the network side the inter-band SSB-less SCell can only be configured when a serving cell with SSB on the corresponding potential ‘reference’ band is configured in the CA operation. Furthermore, the UE can also indicate a featruesetCombination ID and/or other parameters that are different from the basic BC.

FIG. 17D shows an example of a new SSB_Less band entry to the basic BC.

For a non-limiting example, the UE supports basic BC1 including A+B, and SSB_Less BC BC2 including A+B+C (SSB less band Entry), and the Band C's reference band is Band B. The UE can include BC1 including A+B in the above bandCombination, then add Band C in the newly added BandParametersSSBLess and set the Band B as the reference band of the band C. the UE may additionally report a featureSetCombinationID in the newly added “featureSetCombinationIDSSBLess” Field, or report one or more Feature set for the SSB_Less Band C.

Solution 3 includes a legacy BC structure with featuresetDownlink ID=0 to indicate SSB_Less without DL resource (or UL only) case (e.g., Type 3). In some implementations, this solution can be applied to the Type 3, wherein Type 3 includes one or more SSB-less band entry that doesn't support any DL resource.

In some implementations, setting the downlink featureset of the SSB Less band entry to 0 may indicate there is no DL resource on this band Entry.

FIG. 17E shows an example of an SSB_Less band entry with no DL.

For example, referring to FIG. 4, the UE reports BC Band 1+Band 2+Band 3 with featureset Entry 1/2, and SSB_less BC Band 1+Band 2+Band 3 (SSB_less) with featureset Entry 3, in which the band 3 is a SSB Less band with no DL resource, then the UE can set the FeatureSetDownlinkId of the FeatureSet3.3 to 0.

In some implementations, for a legacy gNB that may not support SSB_Less feature, it may only take the featureSetEntry 1/2 into consideration and ignore the FeaturesetEntry 3, while the new gNB (support SSB_Less feature) can read the FeaturesetEntry 3 and take it for the SSB_less BC Band 1+Band 2+Band 3 (SSB_less).

Solution 4 includes indicating the SSB_Less type in the Featureset. In some implementations, referring to FIG. 17F, the UE can indicate the supported SSB_Less types (at least the 3 types as defined above) in the FeatureSet or the FetrueSetDownlink.

Solution 5 include indicating the SSB_Less Type in the BC. In this solution, the SSB less type for the SSB_Less capable band was indicated by BC level.

In the SSB_Less support indication, referring to FIG. 17G and/or 17H, it may indicates the SSB_Less type and/or the reference band list for each SSB_less capable band.

In some implementations, for the above solution 3/4/5, the ‘reference band list for each inter-band SSB-less SCell capable band’ may be reported per BC.

In some implementations, the following alternatives may be considered for the reference band list structure with the above explicit solutions.

(1) For each band on which SSB-less inter-band SCell is supported, a band list is reported to indicate the band which can be used as reference band for the SSB-less inter-band SCell. The inter-band SSB-less SCell can only be configured in case, at least, one serving cell on the reference band is configured in the CA operation.

(2) For each band, which can work as a reference band for inter-band SSB-less SCell, an SSB-less SCell capable band list is reported to indicate the applicable band for SSB-less inter-band SCell. If one serving cell with SSB is configured on the reference band, then inter-band SSB-less SCell on the applicable band list can be configured.

(3) One or multiple band list or band group is configured. The band within the same list/group can be used as reference band for each other. If one serving cell with SSB is configured in CA operation, then inter-band SSB-less SCell can be configured on the other band of the same list/group.

In addition, besides the band information, SSB-less SCell type can be included in the band list/band group as well to indicate the type of SSB-less SCell supported.

In some implementations, methods may include any combination of the above solutions. The above UE capability structure are not limited to indicate the SSB_less feature, it can also extend to any other features that has some special character on one or more bands of the band combination.

The present disclosure describes methods, apparatus, and computer-readable medium for wireless communication. The present disclosure addressed the issues/problems with user equipment (UE) capability coordination in dual-connection (DC). The methods, devices, and computer-readable medium described in the present disclosure may facilitate the performance of wireless transmission between a user equipment and multiple network nodes, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
sending, by a user equipment (UE) to a first network, a UE assistance information comprising UE capability restriction, the UE capability restriction indicating one or more restriction dimensions to the first network,
wherein:
the UE capability restriction comprises a first dimension and a second dimension,
the first dimension comprises an affected band combination (BC) reporting corresponding to an affected BC list,
the second dimension comprises a set of parameter limitations associated with a per band per BC level, and
the set of parameter limitations comprises at least one of the following: a maximum multiple input multiple output (MIMO) layer, or a maximum supported bandwidth.

2. (canceled)

3. The method according to claim 1, wherein:
the UE comprises multiple universal subscriber identification modules (Multi-USIMs) corresponding to a first subscription of the first network and a second subscription of a second network.

4. The method according to claim 1, wherein:
the UE capability restriction comprises restriction information at a granularity level; and
the granularity level comprises at least one of the following per band combination (BC) level, or per band per BC level.

5-12. (canceled)

13. A method for wireless communication, comprising:
receiving, by a first network from a user equipment (UE), a UE assistance information comprising UE temporary capability restriction, the UE capability restriction indicating one or more restriction dimensions to the first network,
wherein:
the UE capability restriction comprises a first dimension and a second dimension,
the first dimension comprises an affected band combination (BC) reporting corresponding to an affected BC list,
the second dimension comprises a set of parameter limitations associated with a per band per BC level, and
the set of parameter limitations comprises at least one of the following: a maximum multiple input multiple output (MIMO) layer, or a maximum supported bandwidth.

14. The method according to claim 13, wherein:
the UE capability restriction comprises restriction information at a granularity level; and
the granularity level comprises at least one of the following: per band combination (BC) level, or per band per BC level.

15-17. (canceled)

18. The method according to claim 13, wherein:
the first network comprises a master node; and
the method further comprises:
sending, by the master node, capability coordination information to a secondary node, the capability coordination information comprising the set of parameter limitations corresponding to the affected BC list, wherein the set of parameter limitations comprises at least one of the following: a maximum MIMO layer, or a maximum supported bandwidth.

19. (canceled)

20. The method according to claim 18, wherein:
the capability coordination information further comprises a second set of parameter limitations at a granularity level; and
the granularity level comprises at least one of the following: per band combination (BC) level, or per band per BC level.

21-22. (canceled)

23. The method according to claim 1, further comprising:
determining, by the UE, a value as a lower one of a first value derived based on affected BCs indicated in the first dimension and a second value reported in the second dimension.

24. The method according to claim 23, wherein:
the second value in the second dimension indicates the corresponding MIMO layers and bandwidths of BCs within the UE capability.

25. A user equipment (UE) comprising:
a memory storing instructions; and
at least one processor in communication with the memory, wherein, when the at least one processor executes the instructions, the at least one processor is configured to cause the UE to perform:
sending, to a first network, a UE assistance information comprising UE capability restriction, the UE capability restriction indicating one or more restriction dimensions to the first network,
wherein:
the UE capability restriction comprises a first dimension and a second dimension,
the first dimension comprises an affected band combination (BC) reporting corresponding to an affected BC list,
the second dimension comprises a set of parameter limitations associated with a per band per BC level, and
the set of parameter limitations comprises at least one of the following: a maximum multiple input multiple output (MIMO) layer, or a maximum supported bandwidth.

26. The UE according to claim 25, wherein:
the UE comprises multiple universal subscriber identification modules (Multi-USIMs) corresponding to a first subscription of the first network and a second subscription of a second network.

27. The UE according to claim 25, wherein:
the UE capability restriction comprises restriction information at a granularity level; and
the granularity level comprises at least one of the following: per band combination (BC) level, or per band per BC level.

28. An apparatus comprising:
a memory storing instructions; and
at least one processor in communication with the memory, wherein, when the at least one processor executes the instructions, the at least one processor is configured to cause the apparatus to perform:
receiving, from a user equipment (UE), a UE assistance information comprising UE capability restriction, the UE capability restriction indicating one or more restriction dimensions to the apparatus,
wherein:
the UE capability restriction comprises a first dimension and a second dimension,
the first dimension comprises an affected band combination (BC) reporting corresponding to an affected BC list,
the second dimension comprises a set of parameter limitations associated with a per band per BC level, and
the set of parameter limitations comprises at least one of the following: a maximum multiple input multiple output (MIMO) layer, or a maximum supported bandwidth.

29. The apparatus according to claim 28, wherein:
the UE capability restriction comprises restriction information at a granularity level; and
the granularity level comprises at least one of the following: per band combination (BC) level, or per band per BC level.

30. The apparatus according to claim 28, wherein:
the apparatus comprises a master node; and
when the at least one processor executes the instructions, the at least one processor is configured to further cause the apparatus to perform:
sending capability coordination information to a secondary node, the capability coordination information comprising the set of parameter limitations corresponding to the affected BC list, wherein the set of parameter limitations comprises at least one of the following: a maximum MIMO layer, or a maximum supported bandwidth.

31. The apparatus according to claim 30, wherein:
the capability coordination information further comprises a second set of parameter limitations at a granularity level; and
the granularity level comprises at least one of the following: per band combination (BC) level, or per band per BC level.

32. The UE according to claim 25, wherein, when the at least one processor executes the instructions, the at least one processor is configured to further cause the UE to perform:
determining a value as a lower one of a first value derived based on affected BCs indicated in the first dimension and a second value reported in the second dimension.

33. The UE according to claim 32, wherein:
the second value in the second dimension indicates the corresponding MIMO layers and bandwidths of BCs within the UE capability.
